(19) United States
(12) Patent Application Publication
(10) Pub. No.: US 2022/0415168 A1
(43) Pub. Date: Dec. 29, 2022

(54) METHODS AND SYSTEMS FOR ADAPTIVE TRAFFIC CONTROL

(71) Applicant: Rapid Flow Technologies, Inc., Pittsburgh, PA (US)

(72) Inventors: Gregory J. Barlow, Pittsburgh, PA (US); Stephen F. Smith, Cheswick, PA (US); Allen Hawkes, Menlo Park, CA (US)

(73) Assignee: Rapid Flow Technologies, Inc., Pittsburgh, PA (US)

(21) Appl. No.: 17/765,903

(22) PCT Filed: Sep. 22, 2020
(86) PCT No.: PCT/US2020/051918

§ 371 Date: Apr. 1, 2022

Related U.S. Application Data
(60) Provisional application No. 62/908,862, filed on Oct. 1, 2019.

(51) Int. Cl. G08G 1/01; G08G 1/08; G08G 1/04; G08G 1/082

(52) U.S. Cl. CPC G08G 1/0145; G08G 1/08; G08G 1/0116; G08G 1/04; G08G 1/0141; G08G 1/082; G06Q 50/30

(57) ABSTRACT

Traffic control systems, signal control systems, and methods of using such systems are disclosed. A real-time adaptive traffic control system includes multiple signal control systems, each associated with a signalized intersection. Each signal control system includes a receiver, a processor, and a transmitter. The receiver receives inflow traffic control information from other signal control systems and information associated with one or more vehicles or devices. The processor generates a signal timing plan based on the information and the inflow traffic control information. The transmitter transmits outflow traffic control information to other signal control systems. A fee or toll may be incurred for receiving the route information associated with a vehicle or device. The result of providing such route information may be better traffic flow for the transmitting vehicle or device and other vehicles or devices resulting from improved information being available to the traffic control system.

### CROSS-REFERENCE TO RELATED APPLICATION

This application claims the benefit of priority to U.S. Provisional Patent Application No. 62/908,862 filed Oct. 1, 2019 and entitled “Methods and Systems for Adaptive Traffic Control”, the disclosure of which is hereby incorporated by reference in its entirety.

### TECHNICAL FIELD

The present disclosure relates generally to methods and systems for real-time adaptive traffic control at signalized intersections. More particularly, the present disclosure relates to real-time adaptive traffic control used to expedite vehicles based on the receipt of vehicle route information and the use of voluntary, incentive-based tolling.

### BACKGROUND

Traffic congestion in urban road networks is a substantial problem that results in significant costs for drivers through wasted time and fuel, detrimental impact to the environment due to increased vehicle emissions, and increased needs for infrastructure upgrades. Poorly timed traffic signals are one of the largest recurring sources of traffic congestion. Even when signals have been recently retimed, the inability to respond to current traffic patterns can cause pockets of congestion that lead to larger traffic jams. Inefficiencies in traffic signal timing stem from poor allocation of green time, inability to respond to real-time conditions, and poor coordination between adjacent intersections.

The operation of traffic signals at a particular intersection is typically governed by a signal timing plan. A timing plan assumes that compatible vehicle movement paths through the intersection (e.g., north and south lanes) have been grouped into movement phases. It specifies the sequence in which phases should be activated (i.e., turned green) and the duration of each green phase. The duration of each phase is subject to minimum and maximum constraints to ensure fairness, and the transition from one phase to the next must obey safety constraints (e.g., fixed-length yellow and all red periods).

Conventional signal systems use pre-programmed timing plans to control traffic signal operation. Fixed timings allocate fixed cycle lengths and green splits, while actuated signals use vehicle detectors to allow minor variations in phase durations within the constraints of the timing plan (e.g., a green phase may be indefinitely allocated to the dominant traffic flow, only shifting to a cross street phase when a waiting vehicle is detected). For coordinated plans, lights often operate in a common cycle length, and offsets are set for coordinated phases between neighbors, on pre-defined corridors. Different timing plans may be invoked at different periods of the day (e.g., during rush and off-peak periods), and the timing plans can impose additional constraints to coordinate the actions of signals at different intersections.

However, such conventional signal systems have a common problem: timing and coordination plans are computed off-line based on expected traffic conditions. Adaptive signal systems, in contrast, sense the actual traffic flows approaching intersections and continually adjust intersection timing plans to match current conditions.

However, such adaptive systems can still suffer from inaccuracies in the information that they receive. For example, in a decentralized setting, if a vehicle is detected at a first intersection and information is passed to a traffic controller at a neighboring intersection, a neighboring traffic controller may adjust its traffic plan to account for the oncoming vehicle. If, however, a vehicle exits the roadway instead of heading to the neighboring intersection, the neighboring traffic controller may generate its timing plan based on inaccurate information. More to the point, even if vehicles location information were detected with 100% accuracy, such information is insufficient to optimize timing plans throughout a traffic control system.

The transportation community has exhibited a growing interest in the integration of traffic signal control with vehicle-to-infrastructure (V2I) communication. For example, the Multi Modal Intelligent Traffic Signal System (MMITSS) uses V2I communication to prioritize different modes of traffic, such as emergency vehicle and mass transit vehicles, through an intersection. However, such systems expedite travel for one class of vehicles at the expense of other classes of vehicles and do not consider the impact of such expedience on the flow of traffic as a whole.

In addition, some companies, such as Connected Signals Inc. and Audi AG, have developed V2I-based techniques that use knowledge of signal timing plans to alert a driver when a traffic signal is about to change to green, yellow, or red. However, providing advance warning of signal transitions places the onus to take advantage of such information entirely on the driver. Moreover, such systems do not expedite traffic flow, but merely seek to provide additional information to the driver of an equipped vehicle.

Other systems implement tolling schemes to control usage of specific roadways and, to a lesser extent, to limit access to congested areas, such as city centers. Tolling and congestion pricing schemes provide blunt instruments in that every vehicle is charged a toll to enter a specific area or roadway. Moreover, the amount of traffic may be lessened using such schemes, but the traffic flow itself is not optimized.

As such, it would be desirable to receive additional information regarding a vehicle's route into a real-time adaptive traffic control system in order to assist in developing timing plans that optimize traffic flow for all vehicles at each intersection along the vehicle's route.

In addition, it would be desirable to provide a fair and equitable mechanism for an operator of a signalized intersection to collect fees from vehicles that are voluntarily sharing their route information and more highly benefiting from the resultant optimization in reduced costs associated with reduced travel time, fuel usage, and emissions.

### BRIEF DESCRIPTION OF THE DRAWINGS

The accompanying drawings, which are incorporated in and form a part of the specification, illustrate the embodiments of the invention and together with the written description serve to explain the principles, characteristics, and features of the invention. In the drawings:

FIG. 1 depicts an illustrative block diagram of a signal control system for a signalized intersection in accordance with an embodiment.

FIG. 2 depicts an illustrative block diagram of a traffic control system in accordance with an embodiment.

FIG. 3A depicts illustrative input flows received by a signal control system in accordance with an embodiment.

FIG. 3B depicts an illustrative signal timing plan for a signalized intersection based on the input flows depicted in FIG. 3A.

FIG. 4 depicts an illustrative flow diagram for a process of controlling traffic flow with vehicle route information in accordance with an embodiment.

FIG. 5 depicts a block diagram of an example environment for operating a traffic control system according to an illustrative embodiment.

### DETAILED DESCRIPTION

The present disclosure describes a real-time adaptive traffic control system that receives route information from vehicles, pedestrians, cyclists, or other individuals or means of transportation and incorporates such information into traffic planning algorithms. In some embodiments, vehicles providing route information may receive enhanced traffic flow as compared with vehicles that do not provide route information. In some embodiments, all vehicles may still receive enhanced traffic flow as compared with non-adaptive traffic control systems.

The present disclosure further describes a system for voluntary, incentive-based tolling at signalized intersections based on real-time use of vehicle route information to improve vehicle traffic flow. In particular, vehicle route information may be broadcast by a device associated with or present in the vehicle to improve the decision of a real-time adaptive traffic control system. For vehicles that are willing to share their route information with the traffic control system, downstream intersections along the vehicle's route are informed in advance of the vehicle's expected arrival time. Because the traffic control system receives route information from the vehicle earlier and with greater accuracy than non-communicating vehicles, the traffic control system can better plan signal transitions, thereby improving traffic flow for all vehicles traversing a signalized intersection. As a result, the overall performance of the traffic control system improves due to the reduction in routing uncertainty, thereby providing a generally greater benefit to vehicles that share their route information as well as a benefit (albeit, lesser) to vehicles that do not share their route information.

In an embodiment, a real-time adaptive traffic control system, such as Surtrac by Rapid Flow Technologies, Inc. of Pittsburgh, Pa., may be used to control traffic signals based on traffic flow information at a plurality of signalized intersections. The traffic control system may include a plurality of signal control systems where each signal control system is associated with a signalized intersection.

As used herein, a “signal control system” refers to an automated system that controls the operation of a plurality of traffic signals at an intersection. Traffic signals may include a traffic light, a pedestrian walk signal, or any other signaling unit that is used to direct traffic flow.

As used herein, a “traffic control system” refers to a network control system that monitors and provides high-level control for one or more signal control systems. If a traffic control system is de-centralized, the traffic control system may include a communication system used to share information amongst different portions of the traffic control system. If a traffic control system is centralized, the traffic control system may include a communication system that provides information to and receives information from a plurality of signal control systems.

As used herein, the term “neighboring signal control system” can be used to refer to a signal control system at an adjacent intersection to an intersection associated with a signal control system, a signal control system at an intersection within a predetermined number of blocks of an intersection associated with a signal control system, or a signal control system at an intersection within a physical distance of an intersection associated with a signal control system. Similarly, a “neighboring intersection” refers to an intersection associated with a neighboring signal control system.

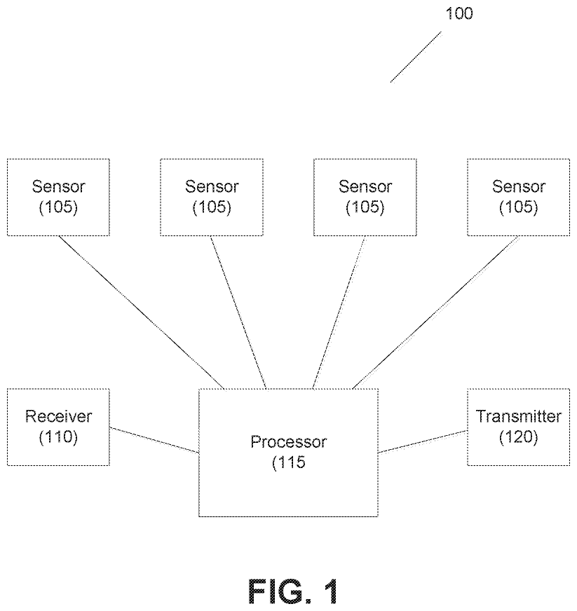

FIG. 1 depicts an illustrative block diagram of a signal control system for a signalized intersection in accordance with an embodiment. As shown in FIG. 1, a signal control system 100 may include one or more sensors 105, a receiver 110, a processor 115, and a transmitter 120.

In an embodiment, at least one of the one or more sensors 105 may be configured to detect location information for at least one vehicle or pedestrian. In an embodiment, at least one of the one or more sensors 105 may be configured to detect velocity information for at least one vehicle or pedestrian. The one or more sensors 105 may include video cameras, still cameras, motion detection sensors, velocity detection sensors (such as forward firing radar systems), induction loops, or the like. In some embodiments, the one or more sensors 105 may be in operable communication with the processor 115 and may transfer sensed information to the processor for processing.

In an embodiment, the receiver 110 may be configured to receive inflow traffic control information from other signal control systems and to receive route information associated with one or more vehicles and/or pedestrians. For example, the receiver 110 may be configured to receive wireless and/or wired transmissions from neighboring signal control systems. For example, the receiver 110 may be configured to receive inflow traffic control information from a signal control system located at an adjacent signalized intersection. In some embodiments, the receiver 110 may be configured to receive inflow traffic control information from any neighboring signal control systems, such as signal control systems within a known radius. In some embodiments, the receiver 110 may be configured to receive route information from a vehicle or a device as described further herein. In some embodiments, the receiver 110 may be in operable communication with the processor 115 and may provide the inflow traffic control information and/or the route information to the processor for processing.

In some embodiments, no sensors 105 may be positioned at a signalized intersection. In such embodiments, the receiver 110 may be configured to receive route information from a vehicle or a device and inflow traffic control information from other signal control systems.

The processor 115 may be configured to generate a signal timing plan for the traffic signal system based on the inflow traffic control information and/or the route information associated with one or more vehicles or devices that is provided by the receiver 110 and/or the one or more of the location information and the velocity information provided by the sensors 105. The timing signal plan may direct a traffic signal system to switch between various states (e.g., green, yellow, and red) at specific times based on the information provided to the processor 115. In some cases, the timing signal plan may decrease delay among vehicles passing through the associated signalized intersection as compared with a non-adaptive system.

A transmitter 120 may be configured to transmit outflow traffic control information to other signal control systems. The outflow traffic control information may be based on at least the one or more of the location information and the velocity information for each of the at least one vehicle or pedestrian. More particularly, at least one of the one or more sensors 105 may identify that one or more vehicles are positioned in a particular lane when traversing the signalized intersection. Based on this identification, the outflow traffic control information may designate that the one or more vehicles are travelling in the direction of a next intersection in the direction serviced by the lane. In some embodiments, route information received from a vehicle or device may designate particular signalized intersections through which the vehicle or device will traverse in the future. In such embodiments, the transmitter 120 may transmit the outflow traffic control information to one or more signal control systems associated with such signalized intersections. In some embodiments, the transmitter 120 may be in operable communication with the processor 115 and may receive the outflow traffic control information to transmit to one or more neighboring signal control systems.

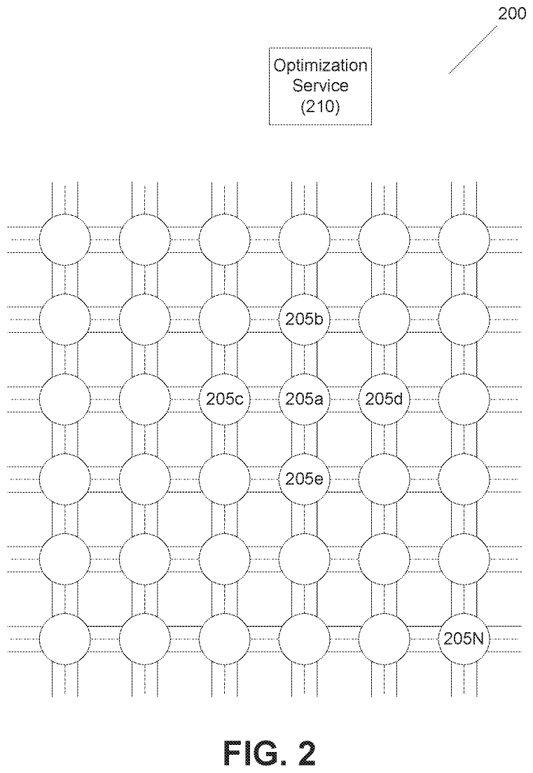

The signal control system associated with a signalized intersection in the controlled road network independently manages the local traffic flow associated with the intersection. In addition, a signal control system at an intersection may share information with signal control systems at neighboring or nearby intersections to achieve coordinated behavior at the network level. FIG. 2 depicts an illustrative block diagram of a traffic control system 200 in accordance with an embodiment. As shown in FIG. 2, a traffic control system 200 may include a plurality of signal control systems 205a-N, such as are described above in reference to FIG. 1. Each signal control system 205a-N may be in wired or wireless communication with one or more other signal control systems. In an embodiment, a signal control system, such as 205a, may be in communication with signal control systems located at adjacent signalized intersections (i.e., 205b-e in FIG. 2). In an embodiment, a signal control system 205a-N may be in communication with signal control systems located no more than a certain number of signalized intersections away, such as 2 intersections, 3 intersections, or the like. In an embodiment, a signal control system 205a-N may be in communication with one or more other signal control systems located within a distance of the signal control system. Such distance may be determined based on, for example and without limitation, a signal strength of a wireless transmitter.

In some embodiments, an optimization service 210 may be used to adapt the operation of the signal control systems to allow traffic to flow more efficiently. The optimization service 210 may receive route information from a vehicle or device and use such information to enable the vehicle or person associated with the route information to progress through signalized intersections more quickly. In some embodiments, the optimization service 210 may include a database of registered vehicles or devices. In some embodiments, the optimization service 210 may impose a toll to the registered vehicle or device in exchange for receiving the information from the vehicle or device. In some embodiments, the optimization service 210 may impose a toll to the registered vehicle or device in exchange for expediting traversal of the vehicle or device through a signalized intersection.

As shown in FIG. 2, the optimization service 210 may be remotely located from the signal control systems 205a-N and transmit information via wired or wireless communication, such as cellular, Wi-Fi, satellite, Dedicated Short-Range Communication (DSRC) radios, or other communication systems. However, in alternate embodiments, the operation of the optimization service 210 may be distributed among the signal control systems 205a-N to allow for local control of the signal control system with input from neighboring signal control systems.

In some embodiments, at the beginning of a planning cycle, the traffic control processor at each intersection accesses information retrieved from a plurality of sensors, such as video cameras, radar, and loops, to detect approaching traffic. A signal timing plan is generated in real-time based on the information that optimizes the movement of all sensed traffic through the intersection. In some embodiments, individual vehicles may be grouped into clusters based on proximity. In such embodiments, each cluster may be considered as a whole. In some embodiments, the model may be based on snapshot information of vehicle locations as the vehicles pass over spatial zones on the roadway when the vehicles are sensed. As such, models incorporating only such information may be susceptible to uncertainty caused by, for example, vehicles entering or leaving the roadway mid-block, inaccuracies in counting vehicles, and the like. Such uncertainty may be mitigated by including vehicle to infrastructure (V2I) communication as described further herein.

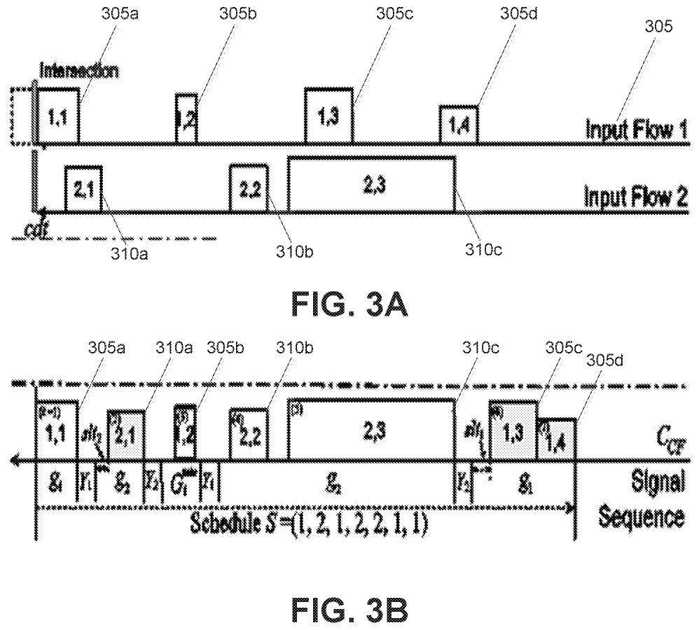

FIG. 3A depicts illustrative input flows received by a signal control system in accordance with an embodiment. As shown in FIG. 3A, a first input flow 305 may correspond to traffic flowing in a first direction, and a second input flow 310 may correspond to traffic flowing in a second direction, such as a direction intersecting the first direction. Although two traffic flows are disclosed in FIG. 3A, additional traffic flows may also be considered when generating a signal timing plan.

Each entry 305a-d, 310a-c in the input flows 305, 310 may include a plurality of characteristics. For example and without limitation, the characteristics for each entry may include the input flow to which the entry corresponds, the entry's position within the input flow sequence, a priority of the entry (designated in FIG. 3A by the height of each entry), an arrival time (designated in FIG. 3A by the leading edge of each entry), and an amount of time required to pass through the intersection (designated in FIG. 3A by the width of each entry). In some embodiments, the priority of an entry may be based on a number of vehicles within the entry. In some embodiments, the priority of the entry may be additionally or alternately based on the type of transports in the entry (pedestrians, cars, emergency vehicles, transit vehicles, etc.) and/or whether one or more vehicles in the entry have shared their route information with the traffic control system.

FIG. 3B depicts an illustrative signal timing plan for a signalized intersection based on the input flows depicted in FIG. 3A. As shown in FIG. 3B, the entries from the input flows have been merged into a traffic control flow based on a traffic signal sequence. In an embodiment, the traffic control flow may be constructed in a manner that seeks to minimize a total delay time for the various entries while satisfying safety constraints (e.g., yellow and red changeover periods) and fairness constraints (e.g., minimum and maximum time constraints on green phases) for the signalized intersection. As shown in FIG. 3B, entries 305a, 305b, 310b, and 310c encountered no delays in traversing the intersection.

In some embodiments, the traffic control processor communicates the expected outflows from the associated intersection to traffic control processors at downstream neighboring intersections. In an embodiment, relevant expected outflows may be transmitted to traffic control processors at downstream neighboring intersections by a wired connection. In an alternate embodiment, expected outflows may be transmitted to traffic control processors at downstream neighboring intersections via a wireless communication protocol. Each traffic control processor at a neighboring intersection uses the outflow information corresponding to its intersection and the local sensor information to construct its local signal timing plan. In this manner, signal timing plans may be generated in a rolling horizon fashion. In some embodiments, the planning cycle may iterate within a given period of time. For example, the planning cycle may iterate every second.

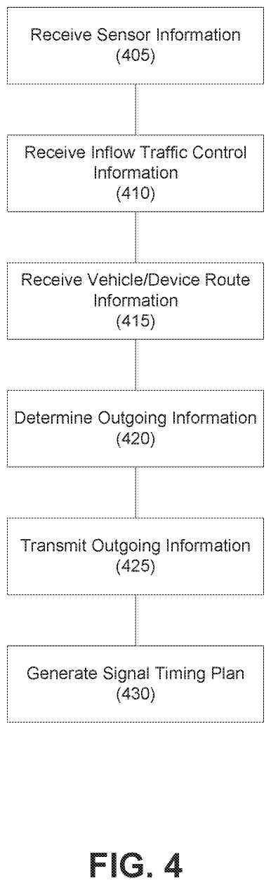

FIG. 4 depicts an illustrative flow diagram for a process of controlling traffic flow with vehicle route information in accordance with an embodiment. As shown in FIG. 4, an optimization service of a traffic control system may receive 405 information from one or more sensors. In some embodiments, the information received 405 from the one or more sensors may include location information pertaining to, for example and without limitation, a vehicle, a plurality of vehicles, a pedestrian, and/or a plurality of pedestrians. In some embodiments, a vehicle may include an automobile, a truck, a bicycle, a scooter, a motorcycle, a transit vehicle (such as a bus), an emergency vehicle, or the like. In some embodiments, a pedestrian or a vehicle may have a corresponding device, which may include a cell phone, a tablet, a phablet, a transmitter, a transponder, or any similar device capable of transmitting and/or receiving information. In some embodiments, a device may be located in a vehicle, such as those listed above. In some embodiments, a device may be associated with a pedestrian, a driver, a passenger, or the like. In some embodiments, the information received 405 from the one or more sensors may include velocity information pertaining to, for example and without limitation, a vehicle, a plurality of vehicles, a pedestrian, and/or a plurality of pedestrians. In an embodiment, the sensors may include cameras, motion detection sensors, velocity detection sensors (such as forward firing radar systems), induction loops, or the like.

In some embodiments, the optimization service of the traffic control system may receive 405 information from sensors associated with a vehicle or device. In some embodiments, a vehicle or device may sense information pertaining to its surroundings via one or more sensors incorporated into the vehicle or the device. For example, a vehicle may include sensors configured to sense the vehicle's surroundings, the speed of the vehicle, the route of the vehicle, and/or the like. In some embodiments, the optimization service of the traffic control system may receive 405 information from a vehicle, such as a transit vehicle, that includes information regarding a number of people that are in transit or other information that may affect the time it is stopped at a transit stop, the likelihood that the transit vehicle will stop at an upcoming transit stop, and/or the like. In some embodiments, the optimization service of the traffic control system may receive 405 information from a vehicle, such as a ride-share vehicle, that includes where a next stop is located for the vehicle, an amount of time the vehicle is likely to spend at the next stop while picking up or releasing passengers, whether the vehicle will block a lane of traffic during the stop, or the like. Those of ordinary skill in the related art will be aware of other information that an optimization service of a traffic control system may receive 405 from a vehicle or device within the scope of this disclosure. Such information may be ubiquitous to vehicles or relate to a class of vehicles depending upon the type of information that is received.

The optimization service of the traffic control system may further receive 410 inflow traffic control information from one or more neighboring signal control systems. The inflow traffic control information may correspond to one or more vehicles or pedestrians that are moving from a signalized intersection monitored by a neighboring signal control system towards the signalized intersection monitored by the signal control system. In some embodiments, the inflow traffic control information may include, without limitation, one or more of a number of vehicles or pedestrians, a velocity of the vehicles or pedestrians, an estimated time of arrival of the vehicles or pedestrians at the signalized intersection monitored by the signal control system, or the like. In some embodiments, inflow traffic control information may be received from a plurality of neighboring signal control systems on a rolling horizon basis.

The optimization service of the traffic control system may further receive 415 route information from a registered vehicle or device. In an embodiment, the route information may be received 415 when the vehicle or device approaches a signal control system that is part of the traffic control system. In an embodiment, the route information may include location data for the vehicle or device, a velocity for the vehicle or device, and a sequence of one or more signalized intersections through which the vehicle or device is intended to traverse.

In some embodiments, a registered vehicle may include a navigation system that includes wireless transmission capability for communicating route information to the traffic control system. In an alternate embodiment, a person, such as a driver associated with a vehicle or a pedestrian, may possess a device, such as a mobile phone, that includes a map/navigation application. In such an embodiment, the map/navigation application may direct the mobile phone to communicate route information to the traffic control system. In some embodiments, the route information may be received 415 via a wireless network, a cellular network, a shortwave communication network, a satellite network, a DSRC network, or the like. The above-listed embodiments are non-limiting and merely exemplary of the manner in which route information may be received 415. Those of ordinary skill in the art will be aware of other comparable methods based on the disclosure herein.

In some embodiments, a fee or a toll may be imposed when route information is received 415 from a registered vehicle or device. A vehicle's route information may improve the ability of the traffic control system and/or a signal control system to determine the signal timing plan for one or more intersections through which the vehicle will traverse, as further set forth below. In particular, the vehicle or device providing the route information may experience quicker traversal through a signalized intersection as a result of providing the route information. However, vehicles that do not provide route information may also experience improved traffic flow through signalized intersections as a result of other vehicles providing route information. This may result because the traffic control system and/or signal control system has improved knowledge of traffic patterns, estimated times of arrival at a particular intersection, and/or the like. As such, improved traffic flow for all vehicles may occur as a result of receiving 415 route information from a registered vehicle or device.

The optimization service may determine 420 and transmit 425 information, such as an estimated time of arrival (ETA) for a vehicle or device, to a signal control system at a next (first) intersection along the route identified by the route information based on the route information, the location data, and/or the velocity. For example, an ETA may be determined 420 based on the distance between the current location of the vehicle or device and the next intersection divided by the velocity of the vehicle or device. Other methods of determining 420 the ETA may also be performed within the scope of this disclosure.

In some embodiments, the optimization service for the traffic control system may be a centrally located processing engine that determines 420 the estimated time of arrival for a plurality of vehicles or pedestrians at a plurality of signalized intersections and transmits 425 relevant information to the signal control systems at each signalized intersection. In some embodiments, the operations of the optimization service may be distributed among the signal control systems at the signalized intersections such that determining 420 the estimated time of arrival for vehicles or pedestrians at each signalized intersection is performed locally. In such embodiments, outflow traffic control information determined about one or more vehicles or pedestrians traversing the signalized intersection associated with a signal control system may be transmitted 425 to a relevant neighboring signal control system towards which the vehicle or pedestrian is progressing. In some embodiments, the route information may be transmitted 425 via a wireless network, a cellular network, a shortwave communication network, a satellite network, a DSRC network, or the like. The above-listed embodiments are non-limiting and merely exemplary of the manner in which route information may be transmitted 425. Those of ordinary skill in the art will be aware of other comparable methods based on the disclosure herein.

In some embodiments, information in addition to or other than the information described above may be determined 420 by and/or transmitted 425 from the optimization service to a relevant signal control system.

In order to generate a signal timing plan in real time at a given intersection, a traffic control processor within a signal control system may generate a predictive model defining when sensed vehicles are expected to arrive at the associated intersection and the direction in which such vehicles are expected to travel to and/or from the intersection. In some embodiments, the predictive model may be based on input flows determined by the signal control system or the traffic control processor in accordance with information received from one or more sensors, inflow traffic control information from neighboring signal control systems and/or route information from vehicles or devices providing such information.

The predictive model may be used to generate 430 a signal timing plan in accordance with the teachings of the present disclosure. In some embodiments, differing levels of priority may be associated with various entries in the input flows based on a number of factors including, for example and without limitation, whether a vehicle in an entry comprises an emergency or transit vehicle, whether a vehicle or a device associated with an entry provides route information, a fee or toll paid in accordance with a vehicle or a device associated with an entry, or the like.

In some embodiments, the optimization service may forward information pertaining to the ETA (or other similar information described above) to signal control systems associated with one or more downstream signalized intersections along the vehicle's (or device's) route. In an embodiment, the optimization service may forward such information to the signal control systems associated with the next two signalized intersections along the vehicle's (or device's) route. In an embodiment, the optimization service may forward such information to the signal control systems associated with the next three signalized intersections along the vehicle's (or device's) route. In this manner, a virtual entry corresponding to the vehicle or device that has shared route information and indicating an approximate ETA may be entered into the input flows for such signal control systems and be assigned a corresponding priority indicative of the fact that the vehicle is being expedited. As the vehicle or device passes through each intersection (and/or on a designated time interval such as every second), the optimization service may provide an updated ETA to the signal control system(s) at the next one or more signalized intersections along the vehicle's or device's route.

One or more mechanisms may be used to communicate route information from a vehicle or device to the optimization service and/or from the optimization service to the traffic control system. In some embodiments, an onboard V2I app that interfaces with an in-vehicle or smartphone-based navigation app may be used to acquire the route information and transmit the route information to the optimization service. In another embodiment, a driver or passenger may directly enter the route into a navigation system within a vehicle, which in turn interacts with the V2I app. In some embodiments, an autonomous vehicle may interact directly with the V2I app to provide route information. Transmission of route information to the optimization service may be performed via direct radio communication (e.g., DSRC), cellular communication or Wi-Fi communication. In some embodiments, the optimization service may be situated at a remote server. In some embodiments, the optimization service may be distributed among the signal control systems at one or more signalized intersections.

In an embodiment, the traffic control system or the optimization service may maintain a registry of eligible vehicles or devices in order to facilitate implementation of tolling mechanisms. In an embodiment, registration of a vehicle or device may require submission of a request for the route sharing service, a subscription enrollment, or the like depending upon the specific registration model employed. For each vehicle or device making use of the optimization service, the system may keep track of the number of signalized intersections traversed for subsequent reconciliation.

Although the present disclosure describes a decentralized traffic control system, a centralized real-time adaptive traffic control system may make use of a predictive model of approaching traffic in accordance with the general teachings described herein.

The description herein is merely exemplary with respect to the components, information and operation of the various embodiments. In particular, additional and/or alternate types of information may be received, determined, transmitted, or used in performing the operations described herein or similar operations. For example, information regarding the number of passengers in a vehicle may be provided in addition to the route information for the vehicle. Providing such information may enable (or restrict) the vehicle's access to a high-occupancy vehicle (HOV) lane or alter signal control operations (if, for example, non-HOV traffic lanes are signalized, but HOV traffic lanes bypass the signal). Numerous other types of information may also be considered for various operations within the scope of this disclosure.

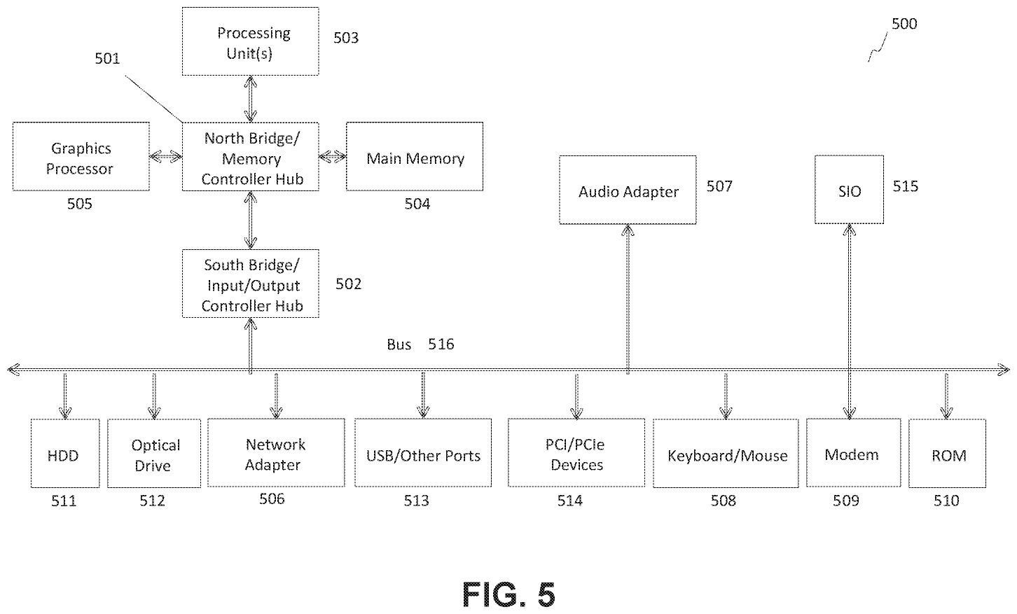

IN FIG. 5 is a block diagram of an example data processing system 500 in which aspects of the illustrative embodiments may be implemented. Data processing system 500 is an example of a computer, such as a server or client, in which computer usable code or instructions implementing the process for illustrative embodiments of the present invention are located. In one embodiment, FIG. 5 may represent a server computing device.

In the depicted example, data processing system 500 can employ a hub architecture including a north bridge and memory controller hub (NB/MCH) 501 and south bridge and input/output (I/O) controller hub (SB/ICH) 502. Processing unit 503, main memory 504, and graphics processor 505 can be connected to the NB/MCH 501. Graphics processor 505 can be connected to the NB/MCH 501 through, for example, an accelerated graphics port (AGP).

In the depicted example, a network adapter 506 connects to the SB/ICH 502. One or more of an audio adapter 507, keyboard and mouse adapter 508, modem 509, read only memory (ROM) 510, hard disk drive (HDD) 511, optical drive (e.g., CD or DVD) 512, universal serial bus (USB) ports and other communication ports 513, and PCI/PCIe devices 514 may connect to the SB/ICH 502 through bus system 516. PCI/PCIe devices 514 may include Ethernet adapters, add-in cards, and PC cards for notebook computers. ROM 510 may be, for example, a flash basic input/output system (BIOS). The HDD 511 and optical drive 512 can use an integrated drive electronics (IDE) or serial advanced technology attachment (SATA) interface. A super I/O (SIO) device 515 can be connected to the SB/ICH 502.

An operating system can run on processing unit 503. The operating system can coordinate and provide control of various components within the data processing system 500. As a client, the operating system can be a commercially available operating system. An object-oriented programming system, such as the Java™ programming system, may run in conjunction with the operating system and provide calls to the operating system from the object-oriented programs or applications executing on the data processing system 500. As a server, the data processing system 500 can be an IBM® eServer™ System p® running the Advanced Interactive Executive operating system or the Linux operating system. The data processing system 500 can be a symmetric multiprocessor (SMP) system that can include a plurality of processors in the processing unit 503. Alternatively, a single processor system may be employed. Additional and/or alternate hardware, software, or operating systems may also be used within the scope of this disclosure.

Instructions for the operating system, the object-oriented programming system, and applications or programs are located on storage devices, such as the HDD 511, and are loaded into the main memory 504 for execution by the processing unit 503. The processes for embodiments described herein can be performed by the processing unit 503 using computer usable program code, which can be located in a memory such as, for example, main memory 504, ROM 510, or in one or more peripheral devices.

A bus system 516 can be comprised of one or more busses. The bus system 516 can be implemented using any type of communication fabric or architecture that can provide for a transfer of data between different components or devices attached to the fabric or architecture. A communication unit such as the modem 509 or the network adapter 506 can include one or more devices that can be used to transmit and receive data.

Those of ordinary skill in the art will appreciate that the hardware depicted in FIG. 5 may vary depending on the implementation. Other internal hardware or peripheral devices, such as flash memory, equivalent non-volatile memory, or optical disk drives may be used in addition to or in place of the hardware depicted. Moreover, the data processing system 500 can take the form of any of a number of different data processing systems, including but not limited to, client computing devices, server computing devices, tablet computers, laptop computers, telephone or other communication devices, personal digital assistants, and the like. Essentially, data processing system 500 can be any known or later developed data processing system without architectural limitation.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A real-time adaptive traffic control system, comprising:
a plurality of signal control systems, wherein each signal control system is associated with a signalized intersection, wherein each signal control system comprises:
a receiver configured to receive inflow traffic control information from other signal control systems of the plurality of signal control systems and to receive route information associated with one or more vehicles,
a processor configured to generate a signal timing plan for a traffic signal system based on the route information associated with the one or more vehicles and the inflow traffic control information, and
a transmitter configured to transmit outflow traffic control information to other signal control systems of the plurality of signal control systems.

2. The traffic control system of claim 1, wherein:
each receiver is configured to receive wireless transmissions from neighboring signal control systems; and
each transmitter is configured to transmit wireless transmissions to neighboring signal control systems.

3. The traffic control system of claim 1, wherein the outflow traffic control information comprises the route information associated with the one or more vehicles.

4. The traffic control system of claim 1, wherein each of the plurality of signal control systems further comprises:
one or more sensors in operable communication with the processor, wherein each sensor is configured to detect one or more of location information for at least one vehicle or pedestrian and velocity information for at least one vehicle or pedestrian,
wherein the processor is further configured to generate the signal timing plan based on the one or more of the location information and the velocity information, and
wherein the outflow traffic control information is based on at least the one or more of the location information and the velocity information for each of the at least one vehicle or pedestrian.

5. The traffic control system of claim 4, wherein the one or more sensors comprise one or more of a video camera, a still camera, a motion detection sensor, a velocity detection sensor, or an induction loop.

6. A signal control system associated with a signalized intersection, wherein the signal control system comprises:
a receiver configured to receive inflow traffic control information and to receive route information associated with one or more vehicles;
a processor configured to generate a signal timing plan for a traffic signal system based on the route information associated with the one or more vehicles and the inflow traffic control information; and
a transmitter configured to transmit outflow traffic control information.

7. The signal control system of claim 6, wherein the receiver comprises a wireless receiver, and wherein the transmitter comprises a wireless transmitter.

8. The signal control system of claim 6, wherein the outflow traffic control information comprises the route information associated with the one or more vehicles.

9. The signal control system of claim 6, further comprising:
one or more sensors, wherein each sensor is configured to detect one or more of location information for at least one vehicle or pedestrian and velocity information for at least one vehicle or pedestrian,
wherein the processor is further configured to generate the signal timing plan based on the one or more of the location information and the velocity information, and
wherein the outflow traffic control information is based on at least the one or more of the location information and the velocity information for each of the at least one vehicle or pedestrian.

10. The signal control system of claim 9, wherein the one or more sensors comprise one or more of a video camera, a still camera, a motion detection sensor, a velocity detection sensor, or an induction loop.

11. A method of adaptive traffic control, comprising:
providing a signal control system in communication with one or more neighboring signal control systems, one or more sensors, and a traffic signal system, wherein the signal control system comprises a traffic control processor that executes the following operations:
receiving inflow traffic control information from the one or more neighboring signal control systems,
receiving route information associated with one or more vehicles,
generating a signal timing plan for the traffic signal system based on the route information associated with the one or more vehicles and the inflow traffic control information,
controlling the traffic signal system based on the signal timing plan, and
transmitting outflow traffic control information to the one or more neighboring signal control systems.

12. The method of claim 11, wherein the traffic control processor further executes the following operations:
receiving from the one or more sensors, one or more of location information for at least one vehicle or pedestrian and velocity information for at least one vehicle or pedestrian,
wherein generating the signal timing plan comprises generating the signal timing plan further based on the one or more of the location information and the velocity information, and
wherein the outflow traffic control information is based on at least the one or more of the location information and the velocity information for each of the at least one vehicle or pedestrian.

13. The method of claim 11, wherein the traffic control processor further executes the following operations:
assigning a first priority level to the one or more vehicles associated with the route information and assigning a second priority level to one or more vehicles not associated with the route information; and
charging a toll to at least one of the vehicles of the one or more vehicles associated with the route information,
wherein generating a signal timing plan is further based on the first and second priority levels.

14. The method of claim 13, wherein:
the first priority level is assigned at least in part based on a number of vehicles associated with the route information; and
the second priority level is assigned at least in part based on a number of vehicles not associated with the route information.

15. The method of claim 13, wherein the signal timing plan substantially minimizes a transit time for the one or more vehicles assigned the first priority level.

16. The method of claim 11, wherein the traffic control processor further executes the following operations:
assigning a first priority level to a first group of one or more vehicles based on a type of vehicle associated with at least one of the one or more vehicles in the first group; and
assigning a second priority level to a second group of one or more vehicles;
wherein generating a signal timing plan is further based on the first and second priority levels.

17. The method of claim 16, wherein the type of vehicle associated with at least one of the one or more vehicles in the first group comprises an emergency vehicle.
